(19) United States
(12) Patent Application Publication
(10) Pub. No.: US 2025/0088597 A1
(43) Pub. Date: Mar. 13, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yasushi UJIGAWA, Kanagawa (JP)

(73) Assignee: FUJIFILM Business Innovation Corp., Tokyo (JP)

(21) Appl. No.: 18/587,986

(22) Filed: Feb. 27, 2024

(30) Foreign Application Priority Data
Sep. 8, 2023 (JP) 2023-146523

(51) Int. Cl. H04N 1/00

(52) U.S. Cl. CPC H04N 1/00811; H04N 1/00005; H04N 1/00013; H04N 1/00037; H04N 1/0009; H04N 1/00413; H04N 2201/0094

(57) ABSTRACT

An information processing system includes a memory, and a processor configured to: in a case where image data generated by reading a document is to be output by multiple different output processes, determine, based on formats of the image data to be output by the output processes, an order of output of the image data by the output processes; store first image data to be output by a first output process that is higher in the order of output among the multiple different output processes into the memory; output the first image data by the first output process; generate, based on the first image data, second image data to be output by a second output process that is lower in the order of output; store the second image data into the memory and delete the first image data from the memory; and output the second image data by the second output process.

### CROSS-REFERENCE TO RELATED APPLICATIONS

This application is based on and claims priority under 35 USC 119 from Japanese Patent Application No. 2023-146523 filed Sep. 8, 2023.

### BACKGROUND

### (i) Technical Field

The present disclosure relates to an information processing system, an information processing method, and a non-transitory computer readable medium.

### (ii) Related Art

A technique for outputting, by multiple different output processes, image data generated by reading a document has been known. In this case, for each of the output processes, image data that has a format corresponding to the output process is generated. Thus, a plurality of pieces of image data that have different formats corresponding to output processes are generated, and the individual pieces of image data are output by the corresponding output processes.

In Japanese Unexamined Patent Application Publication No. 2004-194278, an image processing apparatus that converts image data stored in image storing means into a data format suitable for a terminal used at a transmission destination of the image data is described.

In Japanese Unexamined Patent Application Publication No. 2005-304012, an image processing apparatus that converts the format of image data stored by storing means to match an attribute of image data handled by a client terminal and transmits the converted image data to the client terminal is described.

In Japanese Unexamined Patent Application Publication No. 2003-333266, an image input/output apparatus that converts the resolution of input image data into a predetermined resolution, converts the format of the image data with the converted resolution into a predetermined format, and transmits the converted image data is described.

### SUMMARY

In the case of outputting image data by multiple different output processes, a plurality of pieces of image data that have different formats corresponding to the output processes may be stored into a memory included in a system that outputs the image data. However, depending on the capacity of the memory of the system, it may be difficult to store all the pieces of image data into the memory of the system.

Aspects of non-limiting embodiments of the present disclosure relate to, in the case of outputting, by multiple different output processes, a plurality of pieces of image data that have different formats corresponding to the multiple different output processes, even if a system that outputs image data does not have a memory capable of storing all the pieces of image data, implementing output of the plurality of pieces of image data by the multiple different output processes.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a memory, and a processor configured to: in a case where image data generated by reading a document is to be output by multiple different output processes, determine, based on formats of the image data to be output by the output processes, an order of output of the image data by the output processes; store first image data to be output by a first output process that is higher in the order of output among the multiple different output processes into the memory; output the first image data by the first output process; generate, based on the first image data, second image data to be output by a second output process that is lower in the order of output; store the second image data into the memory and delete the first image data from the memory; and output the second image data by the second output process.

### BRIEF DESCRIPTION OF THE DRAWINGS

Exemplary embodiments of the present disclosure will be described in detail based on the following figures, wherein:

FIG. 1 is a block diagram illustrating a hardware configuration of an image forming apparatus according to an exemplary embodiment;

FIG. 2 is a block diagram illustrating a functional configuration relating to an output process;

FIG. 3 is a flowchart illustrating the flow of a process by the image forming apparatus according to the exemplary embodiment;

FIG. 4 is a block diagram illustrating a configuration of the entire system according to the exemplary embodiment;

FIG. 5 is a diagram illustrating a setting screen;

FIG. 6 is a diagram illustrating settings for output processes according to a first example;

FIG. 7 is a flowchart illustrating the flow of a process according to the first example;

FIG. 8 is a diagram illustrating settings for output processes according to a second example;

FIG. 9 is a diagram illustrating a priority table;

FIG. 10 is a diagram illustrating a setting screen;

FIG. 11 is a flowchart illustrating the flow of a process according to the second example; and

FIG. 12 is a diagram illustrating settings for output processes according to a third example.

### DETAILED DESCRIPTION

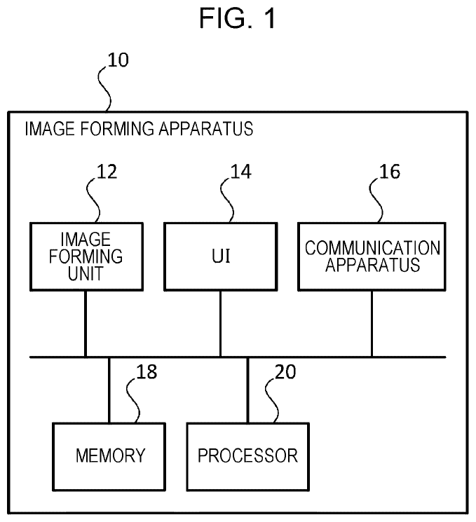

An image forming apparatus 10 according to an exemplary embodiment will be described with reference to FIG. 1. FIG. 1 is a block diagram illustrating a hardware configuration of the image forming apparatus 10.

The image forming apparatus 10 generates image data by reading a document and outputs the image data by multiple different output processes. The image forming apparatus 10 generates, for each of the output processes, image data that has a format corresponding to the output process. The image forming apparatus 10 outputs the individual pieces of image data by the corresponding output processes.

For example, the image forming apparatus 10 includes a scanner and generates image data by reading a document by using the scanner. The image forming apparatus 10 may include a printer and form an image based on image data on a recording medium such as paper. That is, the image forming apparatus 10 may print an image. The image forming apparatus 10 may include a facsimile device and transmit image data to another facsimile device through facsimile communication. The image forming apparatus 10 may be a multifunction machine including a scanner, a printer, a facsimile device, and the like.

An output process is a process of storing image data into a memory, a process of transmitting image data to an external apparatus different from the image forming apparatus 10, or a process of forming an image on a recording medium such as paper (that is, printing).

The memory may be a memory mounted on the image forming apparatus 10 or an external memory connected to the image forming apparatus 10. For example, the external memory is a universal serial bus (USB) memory, a hard disk drive (HDD), or an optical disc (for example, a compact disc (CD), a digital versatile disc (DVD), a Blu-ray disc, or the like). The image forming apparatus 10 performs a process of storing image data into the memory as an example of the output process.

The external apparatus is a personal computer (PC), a tablet PC, a smartphone, a mobile phone, a server, a facsimile apparatus, or the like. The image forming apparatus 10 performs a process of transmitting image data to a PC, a server, or the like via a communication path such as the Internet, a local area network (LAN), or the like as an example of the output process. As another example of the output process, the image forming apparatus 10 performs a process of transmitting image data to a facsimile apparatus through facsimile communication.

A function for outputting image data by multiple different output processes may be referred to as a Multi Job Flow function.

The format of image data is at least one of color mode and resolution. Examples of color mode include color, grayscale, and monochrome. Color image data may be full-color image data (for example, image data reproduced using approximately 16,770,000 colors) or non-full-color image data (for example, image data reproduced without using all 16,770,000 colors). The user may choose the number of colors to be used in color image data.

The multiple different output processes may be processes of outputting to multiple different output destinations image data having formats corresponding to the output destinations or processes of outputting to the same output destination a plurality of pieces of image data that have different formats. An output destination is the memory, an external apparatus, a recording medium such as paper, or the like.

For example, a process of storing image data having a first format into the memory and a process of transmitting the same image data having a second format to a server are an example of processes of outputting image data to multiple different output destinations. The second format and the first format are different from each other.

A process of transmitting image data having a first format to a server and a process of transmitting the same image data having a second format to the same server are an example of processes of outputting image data to the same output destination. The above-mentioned processes of outputting multiple pieces of image data having different formats to the same output destination correspond to an example of multiple different output processes.

An output destination mentioned above is merely an example and the output destination may be any of the memory, an external apparatus, and a recording medium.

As illustrated in FIG. 1, the image forming apparatus 10 includes an image forming unit 12, a user interface (UI) 14, a communication device 16, a memory 18, and a processor 20. The image forming unit 12 includes at least a scanner and has a scan function. That is, the image forming unit 12 has at least a function for generating image data by reading a document. The image forming unit 12 may further include a printer and have a copy function and a print function. That is, the image forming unit 12 may have a function for forming an image based on image data generated by reading a document onto a recording medium such as paper. Furthermore, the image forming unit 12 may form an image based on image data transmitted from an apparatus different from the image forming apparatus 10 onto a recording medium.

The UI 14 is a user interface and includes a display and an operation device. The display is a liquid crystal display, an electroluminescence (EL) display, or the like. The operation device includes a keyboard, a mouse, an input key, an operation panel, or the like. The UI 14 may be a UI such as a touch panel (for example, an operation panel) including both the display and the operation device.

The communication device 16 includes one or a plurality of communication interfaces including a communication chip, a communication circuit, and the like and has a function for transmitting information to other apparatuses and a function for receiving information from other apparatuses. The communication device 16 may have a wireless communication function such as short-range wireless communication, Wi-Fi (registered trademark), or the like and may have a wired communication function. The communication device 16 may also have a facsimile function and transmit image data to other facsimile apparatuses through facsimile communication.

The memory 18 is a device that configurates one or a plurality of storage regions in which data are stored. The memory 18 is, for example, an HDD, a solid state drive (SSD), any type of memory (for example, a random access memory (RAM), a dynamic random access memory (DRAM), a non-volatile random access memory (NVRAM), a read only memory (ROM), or the like), other types of storage device (for example, an optical disc), or a combination of the memories mentioned above. For example, image data generated by reading a document is stored into the memory 18.

The processor 20 controls operations of the units of the image forming apparatus 10.

The processor 20 also outputs image data generated by reading a document by multiple different output processes. In this case, the processor 20 determines, based on formats of the individual pieces of image data to be output by corresponding output processes, the order of output of the individual pieces of image data by the corresponding output processes. The processor 20 stores first image data to be output by a first output process that is higher in the order of output into the memory 18 and outputs the first image data by the first output process. Furthermore, the processor 20 generates, based on the first image data, second image data to be output by a second output process that is lower in the order of output. After generating the second image data, the processor 20 deletes the first image data from the memory 18 and stores the second image data into the memory 18. Then, the processor 20 outputs the second image data by the second output process.

For example, the processor 20 determines the order of output on the basis of whether or not image data to be output is color image data. The processor 20 determines that an output process of outputting color image data is an output process to be executed earlier, and determines that an output process of outputting grayscale image data is an output process to be executed later. For example, in the case where the first output process is a process of outputting color image data and the second output process is a process of outputting grayscale image data, the processor 20 determines that the first output process is an output process to be executed earlier and determines that the second output process is an output process to be executed later. The processor 20 generates second image data based on the first image data. Grayscale image data is able to be generated based on color image data. On the contrary, color image data is unable to be generated based on grayscale image data. Hence, the processor 20 determines that an output process of outputting color image data is an output process to be executed earlier and determines that an output process of outputting grayscale image data is an output process to be executed later. That is, in the case where the first image data to be output by the first output process is color image data and the second image data to be output by the second output process is not color image data (for example, in the case where the second image data is grayscale image data), the processor 20 generates the second image data based on the first image data. After performing output by the first output process, the processor 20 performs output by the second output process.

In the case where both the first image data and the second image data are color image data, the processor 20 determines the order of output on the basis of resolution. The processor 20 determines that an output process of outputting image data with a high resolution is an output process to be executed earlier and determines that an output process of outputting image data with a low resolution is an output process to be executed later. Image data with a low resolution is able to be generated based on image data with a high resolution. On the contrary, image data with a high resolution is unable to be generated based on image data with a low resolution. Hence, the processor 20 determines that an output process of outputting image data with a high resolution is an output process to be executed earlier and determines that an output process of outputting image data with a low resolution is an output process to be executed later. For example, in the case where the resolution of the first image data is higher than the resolution of the second image data, the processor 20 generates the second image data based on the first image data. After performing output by the first output process, the processor 20 performs output by the second output process.

In the case where both the first image data and the second image data are color image data and the resolution of the first image data and the resolution of the second image data are the same, the processor 20 determines the order of output processes on the basis of priority levels set in advance. The priority levels may be set by a user. Furthermore, the priority levels may be set every time that image data is output.

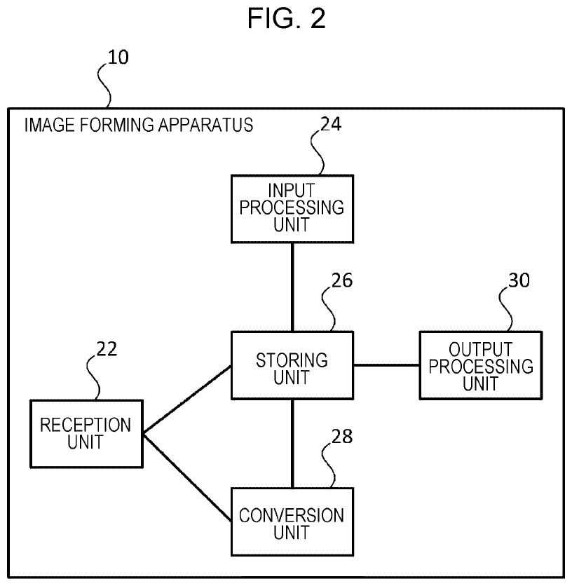

A function regarding an output process will be described with reference to FIG. 2. FIG. 2 is a block diagram illustrating a functional configuration regarding an output process.

The image forming apparatus 10 includes, as a function regarding an output process, a reception unit 22, an input processing unit 24, a storing unit 26, a conversion unit 28, and an output processing unit 30.

The reception unit 22 receives selection of an output process. For example, the processor 20 provides a user interface for allowing the user to select an output process. Specifically, the processor 20 displays on the display of the UI 14 a selection screen for allowing the user to select an output process. The user selects, on the selection screen, an output process to be executed. The reception unit 22 receives selection made by the user. An output process selected by the user is executed by the image forming apparatus 10.

Furthermore, the user selects a format of image data corresponding to an output process. That is, the user selects a format of image data to be output by an output process. For execution of multiple different output processes, the user selects, for each of the output processes, a format of image data. The user may select a format of image data on the selection screen or may select a format of image data on a screen different from the selection screen mentioned above. The reception unit 22 receives selection made by the user regarding the format of image data.

The format of image data may be set in advance for each output process. In this case, when an output process is selected by the user, the format of image data corresponding to the selected output process is selected. Even in this case, the format of image data may be changed by the user.

The input processing unit 24 receives input of image data to be subjected to an output process. For example, when the image forming unit 12 generates image data by reading a document, the input processing unit 24 receives input of the image data and stores the image data into the storing unit 26.

The storing unit 26 is implemented by the memory 18. The storing unit 26 stores image data to be subjected to an output process.

The conversion unit 28 performs conversion of the format of image data to generate image data having a format corresponding to an output process selected by the user. The image data whose format has been converted is stored into the storing unit 26.

The output processing unit 30 executes an output process selected by the user. The image forming unit 12, the communication device 16, or the memory 18 is used according to an output process.

The reception unit 22, the input processing unit 24, the conversion unit 28, and the output processing unit 30 are implemented by the processor 20. To implement the reception unit 22, the input processing unit 24, the conversion unit 28, and the output processing unit 30 by the processor 20, the communication device 16 and the memory 18 may be used.

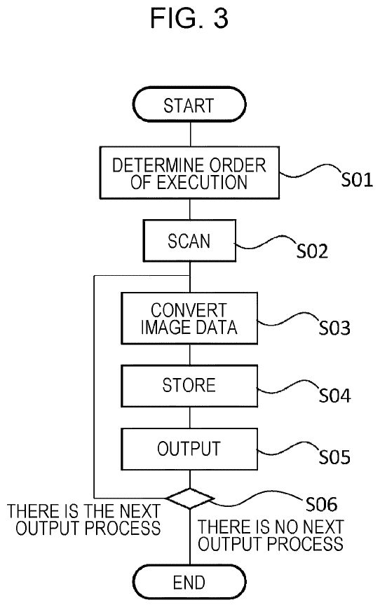

A process by the image forming apparatus 10 will be described with reference to FIG. 3. FIG. 3 is a flowchart illustrating the flow of a process by the image forming apparatus 10.

For example, multiple different output processes are selected by the user. The image forming apparatus 10 executes the multiple different output processes in order.

First, the processor 20 determines, based on formats of individual pieces of image data to be output by corresponding output processes, the order of output of the individual pieces of image data by the corresponding output processes (S01). That is, the processor 20 determines the order of execution of the output processes. The details of a method for determining the order of execution will be described later.

Next, the processor 20 performs scanning using the image forming unit 12 (S02). That is, the image forming unit 12 generates image data by reading a document. For example, the image forming unit 12 generates image data based on which image data to be output by individual output processes to be executed are able to be generated. The image forming unit 12 may generate image data to be output by an output process that is to be executed first.

Next, the processor 20 converts the format of the image data generated by reading the document (S03). For example, the processor 20 converts the format of the image data generated by reading the document into a format of image data to be output by the output process to be executed first. In the case where image data to be output by the output process to be executed first is generated in step S02, the conversion processing is not performed.

Next, the processor 20 stores the image data converted in step S03 into the memory 18 (S04). For example, the processor 20 stores image data to be output by the output process to be executed first (hereinafter, for the sake of convenience, referred to as “image data 1”) into the memory 18.

Next, the processor 20 executes the output process (S05). For example, by executing the output process to be executed first, the processor 20 outputs the image data as a target of the output process to be executed first (that is, image data 1).

In the case where there is no output process to be executed subsequent to the output process executed in step S05 (S06, there is no next output process), the process ends.

In the case where there is an output process to be executed subsequent to the output process executed in step S05 (S06, there is the next output process), the process returns to step S03.

For example, in the case where there is the output process to be executed second, when the output process to be executed first is executed in step 505, processing from steps S03 to S05 is performed for the output process to be executed second.

Specifically, the processor 20 reads the image data 1 stored in the memory 18 and converts the format of the image data 1 into a format of image data to be output by the output process to be executed second (hereinafter, for the sake of convenience, referred to as “image data 2”) (S03). After generating the image data 2, the processor 20 deletes the image data 1 from the memory 18 and stores the image data 2 into the memory 18 (S04). Next, by executing the output process to be executed second, the processor 20 outputs the image data 2.

In the case where there is no output process to be executed third (S06, there is no next output process), the process ends. In the case where there is an output process to be executed third (S06, there is the next output process), the process returns to step S03. As with the output process to be executed second, the processing from steps S03 to S05 is performed for the output process to be executed third.

As described above, multiple different output processes are executed without storing all the pieces of image data to be output by the multiple different output processes into the memory 18. Hence, the memory does not need to secure a capacity large enough to store all the pieces of image data to be output by the multiple different output processes. As described in the example provided above, the output process to be executed first and the output process to be executed second are executed without storing both the image data 1 and the image data 2 into the memory 18. Hence, the memory does not need to secure a capacity large enough to store both the image data 1 and the image data 2. In other words, even if a memory that has a capacity large enough to store all the pieces of image data is not mounted on the image forming apparatus 10, multiple different output processes are able to be executed.

Examples will be described below.

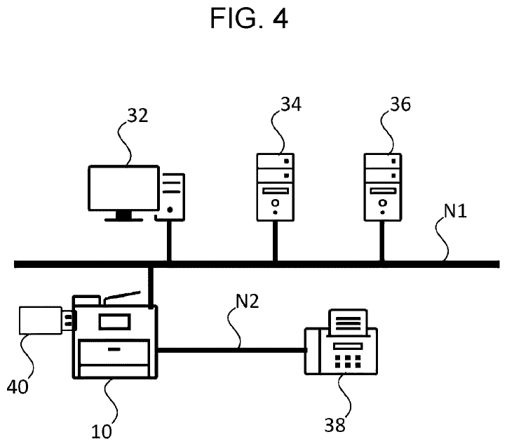

The entire system including the image forming apparatus 10 will be described with reference to FIG. 4. FIG. 4 is a block diagram illustrating the entire system.

For example, the entire system includes the image forming apparatus 10, a PC 32, a server 34, a server 36, and a facsimile apparatus 38. Furthermore, a USB memory 40 is connected to the image forming apparatus 10. The PC 32, the servers 34 and 36, and the facsimile apparatus 38 are examples of external apparatuses. The USB memory 40 is an example of an external memory.

The image forming apparatus 10, the PC 32, the server 34, and the server 36 communicate with other apparatuses via a communication path N1. For example, the communication path N1 is a network such as the Internet or a LAN. The communication path N1 may be established by wired communication or established by wireless communication such as Wi-Fi. The image forming apparatus 10 and the facsimile apparatus 38 perform facsimile communication via a communication path N2. For example, the communication path N2 is a telephone line.

The configuration illustrated in FIG. 4 is merely an example. A plurality of PCs may be included in the entire system or a PC is not necessarily included in the entire system. A single server may be included in the entire system or a server is not necessarily included in the entire system. A plurality of facsimile apparatuses may be included in the entire system or a facsimile apparatus is not necessarily included in the entire system. An external memory such as the USB memory 40 is not necessarily connected to the image forming apparatus 10 or an external memory different from the USB memory 40 may be connected to the image forming apparatus 10.

For example, the image forming apparatus 10 includes, as output processes, ScanToPC, ScanToServer, ScanToUSB, FAX, and Copy.

ScanToPC is a process of transmitting image data generated by reading a document by using a scanner to a PC from the image forming apparatus 10 via the communication path N1.

ScanToServer is a process of transmitting image data generated by reading a document by using a scanner to a server via the communication path N1.

ScanToUSB is a process of storing image data generated by reading a document by using a scanner into the USB memory connected to the image forming apparatus 10.

FAX is a process of transmitting image data generated by reading a document by using a scanner via the communication path N2.

The Copy function is a process of printing an image based on image data generated by reading a document by using a scanner onto a recording medium such as paper.

The image forming apparatus 10 has a function for executing selected multiple different output processes (that is, the Multi Job Flow function). That is, the image forming apparatus 10 has a function for executing multiple output processes with respect to a single input process (that is, a single scan process). Obviously, the image forming apparatus 10 may have a function for separately executing individual output processes.

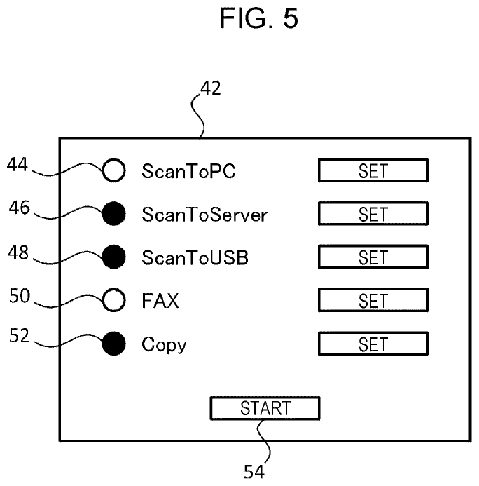

A selection screen will be described with reference to FIG. 5. FIG. 5 illustrates a selection screen 42. The selection screen 42 is a screen for allowing a user to select an output process.

For example, when the user operates the UI 14 to provide an instruction to display the selection screen 42, the processor 20 displays the selection screen 42 on the display of the UI 14.

The list of multiple different output processes is displayed on the selection screen 42. The multiple output processes are output processes that the image forming apparatus 10 is capable of executing.

For example, ScanToPC, ScanToServer, ScanToUSB, FAX, and Copy are displayed as examples of output processes on the selection screen 42.

Furthermore, checkboxes 44 to 52 are displayed on the selection screen 42. A checkbox is an image for allowing the user to select an output process to be executed. The checkbox 44 corresponds to ScanToPC. The checkbox 46 corresponds to ScanToServer. The checkbox 48 corresponds to ScanToUSB. The checkbox 50 corresponds to FAX. The checkbox 52 corresponds to Copy.

In the example illustrated in FIG. 5, ScanToServer, ScanToUSB, and Copy are selected by the user as output processes to be executed.

Settings for individual output processes may be performed. For example, items including the color mode of image data to be output, the resolution of image data to be output, and the number of copies are set for each output process. When the user makes selection regarding the color mode and the resolution of image data, the number of copies, and the like for each output process, the selected contents are set for the output process. Furthermore, in the case where a plurality of servers, a plurality of PCs, or a plurality of facsimile apparatuses are included in the entire system, a server, a PC, or a facsimile apparatus as a transmission destination of image data is selected as setting contents. Setting contents of individual output processes may be set in advance. Even in this case, the user may change the setting contents.

A start button 54 is displayed on the selection screen 42. When the user presses the start button 54 on the selection screen 42, the processor 20 executes a process in accordance with the procedure illustrated in FIG. 3. In the example illustrated in FIG. 5, ScanToServer, ScanToUSB, and Copy are executed in a determined order.

The user may select a single output process on the selection screen 42. In this case, the processor 20 executes the selected output process.

### FIRST EXAMPLE

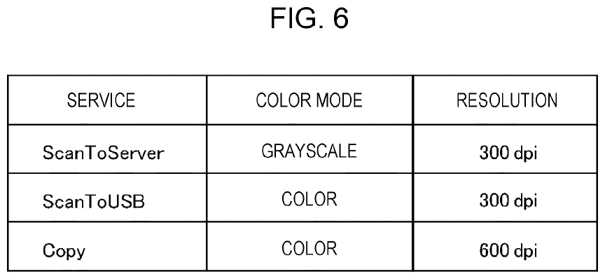

A first example will be described below. The order of execution of output processes will be described with reference to FIG. 6. FIG. 6 illustrates settings for output processes according to the first example. “Service” indicated in FIG. 6 represents an output process.

In the first example, ScanToServer, ScanToUSB, and Copy are selected as output processes to be executed.

The color mode of ScanToServer is grayscale. The resolution of ScanToServer is 300 dpi. That is, image data to be transmitted to a server by ScanToServer is grayscale image data with the resolution of 300 dpi.

The color mode of ScanToUSB is color. The resolution of ScanToUSB is 300 dpi. That is, image data to be stored into the USB memory by ScanToUSB is color image data with the resolution of 300 dpi.

The color mode of Copy is color. The resolution of Copy is 600 dpi. That is, image data to be subjected to Copy is color image data with the resolution of 600 dpi.

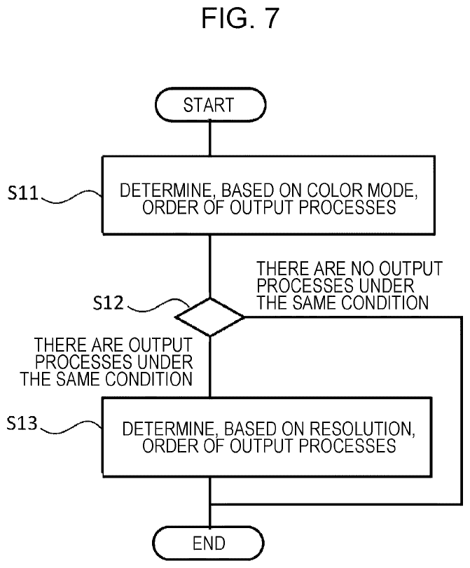

A process according to the first example will be described with reference to FIG. 7. FIG. 7 is a flowchart illustrating the flow of the process according to the first example. The processor 20 checks color mode and resolution on the basis of contents of settings for output processes to be executed.

First, the processor 20 determines, based on color modes of individual pieces of image data to be output by corresponding output processes, the order of the output processes (S11).

In the case where there are no multiple output processes under the same color mode condition (S12, there are no output processes under the same condition), the process for determining the order of output ends.

In the case where there are multiple output processes under the same color mode condition (S12, there are output processes under the same condition), the processor 20 determines the order of the output processes on the basis of resolution (S13).

In the example illustrated in FIG. 6, the color mode of each of ScanToUSB and Copy is color, and the color mode of ScanToServer is grayscale. Since there are multiple output processes under the same color mode condition, the processor 20 performs the processing of step S13.

The processor 20 determines that an output process of outputting color mode image data is to be executed earlier than an output process of outputting grayscale image data. Thus, the processor 20 determines that ScanToServer is the output process to be executed third. At this stage, the order of ScanToUSB and Copy is not determined.

Next, the processor 20 determines the order of the output processes on the basis of the resolution of the image data to be output by ScanToUSB and the resolution of the image data to be output by Copy (S13). The processor 20 determines that an output process of outputting image data with a high resolution is to be executed earlier than an output process of outputting image data with a low resolution.

In the example illustrated in FIG. 6, the resolution of Copy is 600 dpi, and the resolution of ScanToUSB is 300 dpi. Thus, the processor 20 determines that Copy is an output process to be executed earlier than ScanToUSB.

As described above, the processor 20 determines that Copy is the output process to be executed first, ScanToUSB is the output process to be executed second, and ScanToServer is the output process to be executed third. The processor 20 executes the output processes in this order.

When the order of the output processes is determined, the image forming unit 12 reads a document. For example, the image forming unit 12 generates image data that has a format corresponding to Copy, which the output process to be executed first, by reading a document. In the example illustrated in FIG. 6, the image forming unit 12 generates color image data with the resolution of 600 dpi (hereinafter, referred to as “first image data”). The processor 20 stores the first image data into the memory 18.

The processor 20 outputs the first image data stored in the memory 18 by executing Copy, which is the output process to be executed first. Specifically, an image based on the first image data is printed on a recording medium such as paper.

When Copy, which is the output process to be executed first, ends, the processor 20 generates image data that has a format corresponding to ScanToUSB, which is the output process to be executed second, on the basis of the first image data stored in the memory 18. In the example illustrated in FIG. 6, the processor 20 generates color image data with the resolution of 300 dpi (hereinafter, referred to as “second image data”) on the basis of the color image data with the resolution of 600 dpi (that is, the first image data). The processor 20 stores the second image data into the memory 18. When storing of the second image data into the memory 18 is completed, the processor 20 deletes the first image data from the memory 18.

Next, the processor 20 outputs the second image data stored in the memory 18 by executing ScanToUSB, which is the output process to be executed second. Specifically, the processor 20 stores the second image data into the USB memory 40.

When ScanToUSB, which is the output process to be executed second, ends, the processor 20 generates image data that has a format corresponding to ScanToServer, which is the output process to be executed third, on the basis of the second image data stored in the memory 18. In the example illustrated in FIG. 6, the processor 20 generates grayscale image data with the resolution of 300 dpi (hereinafter, referred to as “third image data”) on the basis of the color image data with the resolution of 300 dpi (that is, the second image data). The processor 20 stores the third image data into the memory 18. When storing of the third image data into the memory 18 is completed, the processor 20 deletes the second image data from the memory 18.

Next, the processor 20 outputs the third image data stored in the memory 18 by executing ScanToServer, which is the output process to be executed third. Specifically, the third image data is transmitted to a server. For example, in the case where the server 34 is specified as a transmission destination server, the processor 20 transmits the third image data to the server 34. For example, the third image data is stored into the server 34.

In the case where there is no output process to be executed subsequent to the output process to be executed third, the processor 20 deletes the third image data stored in the memory 18. Thus, execution of the output processes ends.

In the case where a document to be read has multiple pages, image data may be converted in units of output processes or image data may be converted in units of pages.

In the first example described above, conversion, storing, output, and deletion of image data is performed in units of output processes. That is, when output of the first image data by the first output process ends, the second image data is generated and stored into the memory 18. When storing of the second image data into the memory 18 is completed, the processor 20 deletes the first image data stored in the memory 18. This means that when the output process to be executed first ends and generation and storing of the second image data to be output by the output process to be executed second is completed, the first image data output by the output process executed first is deleted. For example, in the case where a document includes multiple pages, the processor 20 outputs the first image data indicating the multiple pages by the output process to be executed first. When the output process to be executed first ends and generation and storing of the second image data indicating the multiple pages is completed, the processor 20 deletes the first image data output by the output process executed first (for example, the first image data indicating the multiple pages) from the memory 18.

In another example, conversion, storing, output, and deletion of image data may be performed in units of pages. For example, the processor 20 generates first image data of the first page for the output process to be executed first (that is, first image data indicating the first page), stores the generated first image data indicating the first page into the memory 18, and outputs the first image data indicating the first page by the output process to be executed first. When output of the first image data indicating the first page ends, the processor 20 generates second image data of the first page for the output process to be executed second (that is, second image data indicating the first page) on the basis of the first image data indicating the first page. When generation of the second image data of the first page is completed, the processor 20 deletes the first image data of the first page stored in the memory 18, and stores the second image data of the first page into the memory 18. Then, the processor 20 outputs the second image data of the first page by the output process to be executed second. For the output process to be executed third and later output processes, conversion, storing, output, and deletion of image data is performed for each page in a similar manner. When output regarding the first page by all the output processes ends, the processor 20 performs conversion, storing, output, and deletion of image data of the second page, in a similar manner to the case of the first page.

By performing conversion, storing, output, and deletion of image data in units of pages, image data of an unnecessary page does not need to be stored in the memory 18. Thus, there is no need to secure a memory capacity for storing such image data.

After completing output of the first image data of the first page by the output process to be executed first, the processor 20 may output first image data of the second page by the output process to be executed first. The same applies to the output processes to be executed second and later.

The same may be applied to second and third examples described later. Conversion, storing, output, and deletion of image data may be performed in units of output processes. Alternatively, conversion, storing, output, and deletion of image data may be performed in units of pages.

### SECOND EXAMPLE

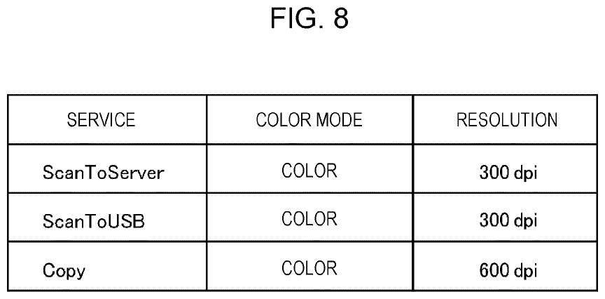

A second example will be described below. The order of execution of output processes will be described with reference to FIG. 8. FIG. 8 illustrates settings for output processes according to the second example. “Service” indicated in FIG. 8 represents an output process.

In the second example, ScanToServer, ScanToUSB, and Copy are selected as output processes to be executed, as in the first example.

The color mode of ScanToServer is color. The resolution of ScanToServer is 300 dpi. That is, image data to be transmitted to a server by ScanToServer is color image data with the resolution of 300 dpi.

The color mode of ScanToUSB is color. The resolution of ScanToUSB is 300 dpi. That is, image data to be stored into the USB memory by ScanToUSB is color image data with the resolution of 300 dpi.

The color mode of Copy is color. The resolution of Copy is 600 dpi. That is, image data to be subjected to Copy is color image data with the resolution of 600 dpi.

The color modes of ScanToServer and ScanToUSB are the same, and the resolutions of image data of ScanToServer and ScanToUSB are the same. Thus, the order of execution of ScanToServer and ScanToUSB is not determined based on color mode and resolution. In this case, the processor 20 determines the order of execution of ScanToServer and ScanToUSB on the basis of priority levels set in advance.

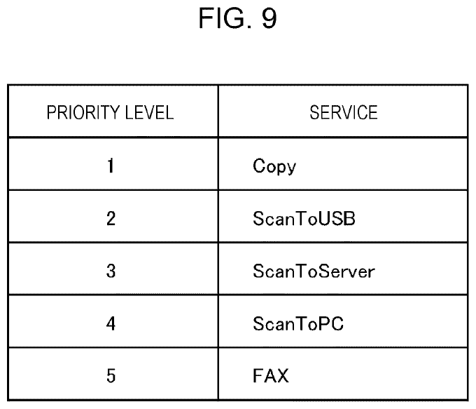

The priority levels set in advance will be described with reference to FIG. 9. FIG. 9 illustrates a priority table. The priority table is a table for setting priority levels for determining the order of output processes. Data in the priority table are stored in advance in the memory 18. “Service” indicated in FIG. 9 represents an output process.

For example, Copy is given the first priority, ScanToUSB is given the second priority, ScanToServer is given the third priority, ScanToPC is given the fourth priority, and FAX is given the fifth priority.

For example, the priority level of an output process in which the user needs to perform an operation or action on the image forming apparatus 10 is set higher than the priority level of an output process in which the user does not need to perform an operation or action on the image forming apparatus 10. Specifically, in the case where Copy is executed, the user normally needs to move to the location of the image forming apparatus 10 to collect printed paper. Furthermore, in the case where ScanToUSB is executed, the user normally needs to perform an operation for removing the USB memory from the image forming apparatus 10. The user who has issued an instruction to execute an output process mentioned above is assumed to wait near the image forming apparatus 10 until the output process ends. On the other hand, in the case where ScanToServer, ScanToPC, or FAX is executed, the user is normally assumed not to wait near the image forming apparatus 10 until the output process ends. Thus, in order to reduce the wait time for the user who has issued an instruction to execute Copy or ScanToUSB, the priority levels of Copy and ScanToUSB are set higher than priority levels of other output processes.

Obviously, the priority levels indicated in FIG. 9 are merely examples. Other priority levels may be set in advance or priority levels may be set by the user.

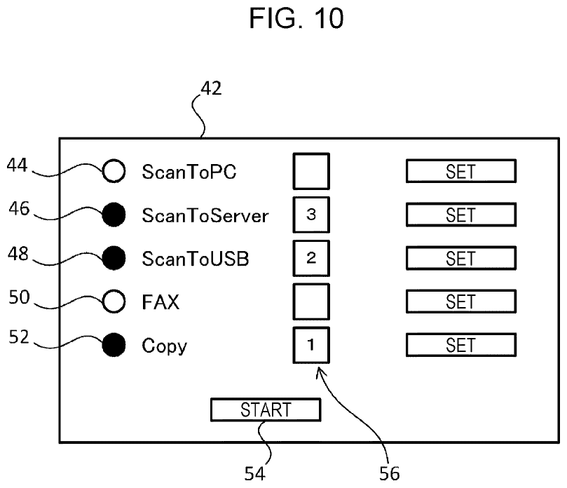

An example in which the user sets priority levels will be described with reference to FIG. 10. FIG. 10 illustrates a selection screen 42.

In the example illustrated in FIG. 10, an entry field 56 is displayed on the selection screen 42. The entry field 56 is a field in which the user sets priority levels of output processes. The entry field 56 includes entry boxes corresponding to the output processes. The user enters priority levels into the entry boxes.

For example, Copy is given the first priority, ScanToUSB is given the second priority, and ScanToServer is given the third priority. The processor 20 determines the order of output of multiple output processes with the same color mode and the same resolution on the basis of the priority levels set as described above.

The selection screen 42 illustrated in FIG. 10 is an example of a user interface for allowing the user to set output processes and priority levels. Priority levels may be set on a screen different from the selection screen 42.

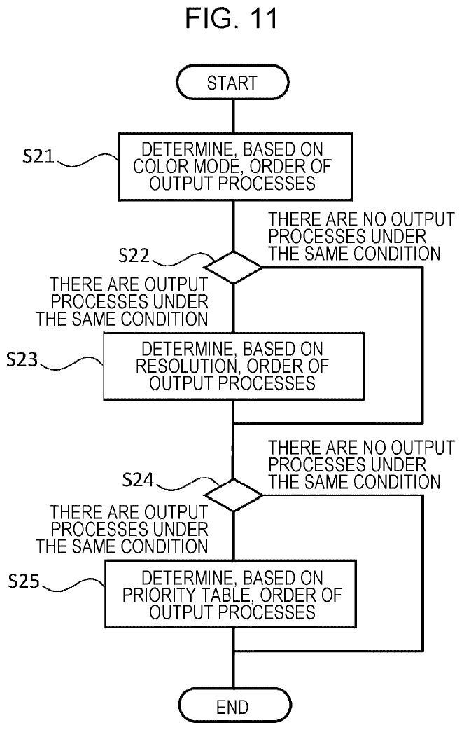

A process according to the second example will be described with reference to FIG. 11. FIG. 11 is a flowchart illustrating the flow of the process according to the second example.

First, the processor 20 determines, based on color modes of individual pieces of image data to be output by corresponding output processes, the order of the output processes (S21).

In the case where there are no multiple output processes under the same color mode condition (S22, there are no output processes under the same condition), the process for determining the order of output ends through step S24 (S24, there are no output processes under the same condition).

In the example illustrated in FIG. 8, color modes of all the output processes are the same. Thus, the processor 20 does not determine the order of output in step S21. The process proceeds to step S23 (S22, there are output processes under the same condition).

Next, the processor 20 determines, based on resolutions of the individual pieces of image data to be output by the corresponding output processes, the order of the output processes (S23).

In the example illustrated in FIG. 8, the resolution of Copy is 600 dpi, and the resolutions of ScanToUSB and ScanToServer are 300 dpi. Thus, the processor 20 determines that Copy is the output process to be executed first. Since the resolutions of ScanToUSB and ScanToServer are the same, the order of ScanToUSB and ScanToServer is not determined at this stage.

In the case where there are no multiple output processes under the same resolution condition (S24, there are no output processes under the same condition), the process for determining the order of output ends.

In the case where there are multiple output processes under the same resolution condition (S24, there are output processes under the same condition), the processor 20 determines the order of output processes for which the order has not been determined, on the basis of the priority table (S25).

In the example illustrated in FIG. 8, since the resolutions of ScanToUSB and ScanToServer are the same, the processor 20 determines the order of ScanToUSB and ScanToServer on the basis of the priority table.

In the example illustrated in FIG. 9, ScanToUSB is given the second priority, and ScanToServer is given the third priority. Thus, the processor 20 determines that ScanToUSB is the output process to be executed second and determines that ScanToServer is the output process to be executed third.

As described above, the processor 20 determines that Copy is the output process to be executed first, ScanToUSB is the output process to be executed second, and ScanToServer is the output process to be executed third. The processor 20 executes the output processes in this order.

When the order of the output processes is determined, a document is read, and the output processes are executed in the order described above, as in the first example. That is, when Copy is executed for first image data as a target and Copy ends, second image data is generated based on the first image data. ScanToUSB is executed for the second image data as a target.

In the second example, the format of image data to be output by ScanToUSB, which is the output process to be executed second (hereinafter, referred to as “second image data”), and the format of image data to be output by ScanToServer, which is the output process to be executed third (hereinafter, referred to as “third image data”), are the same. That is, the color mode of the second image data and the color mode of the third image data are the same, and the resolution of the second image data and the resolution of the third image data are the same.

In this case, the processor 20 does not generate third image data based on the second image data. The processor 20 executes ScanToServer for the second image data stored in the memory 18 (that is, image data to be subjected to ScanToUSB) as the third image data. That is, the processor 20 reuses the second image data as the third image data. When ScanToUSB ends, the processor 20 transmits the second image data as the third image data to a transmission destination server by executing ScanToServer without deleting the second image data from the memory 18. Thus, conversion for separately generating third image data is unnecessary. When ScanToServer ends, the processor 20 deletes the second image data from the memory 18.

Priority levels described above may be set every time that image data is output by an output process. For example, every time that the Multi Job Flow function is executed, priority levels of output processes are set by the user on the selection screen 42 illustrated in FIG. 10. Every time that the Multi Job Flow function is executed, the same priority levels may be set or different priority levels may be set.

### THIRD EXAMPLE

A third example will be described below. In the third example, the processor 20 first determines the order of output processes on the basis of color mode and then determines the order of output processes on the basis of resolution, as in the first and second examples. In the determination method described above, image data to be output by an output process that is lower in the order might be unable to be generated based on image data to be output by an output process that is higher in the order. For example, image data to be output by the output process to be executed third might be unable to be generated based on image data to be output by the output process to be executed second. In the third example, a process for handling this situation is executed.

In the third example, at least the output process to be executed first, the output process to be executed second, and the output process to be executed third are executed. In this case, if image data to be output by the output process to be executed third (hereinafter, referred to as “third image data” in the third example) is unable to be generated based on image data to be output by the output process to be executed second (hereinafter, referred to as “second image data” in the third example), the processor 20 generates the third image data based on image data to be output by the output process to be executed first (hereinafter, referred to as “first image data” in the third example). That is, the processor 20 generates the third image data by converting the format of the first image data. As in the first and second examples, the processor 20 generates the second image data based on the first image data.

For example, there may be a case where the second image data is color image data, the third image data is not color image data, and the resolution of the second image data is lower than the resolution of the third image data. In this case, the processor 20 generates the second image data and the third image data on the basis of the first image data.

In the case where the order of output processes is determined based on color mode, an output process of outputting color image data is executed earlier than an output process of outputting grayscale image data. Thus, an output process of outputting color image data with a low resolution may be set as the output process to be executed second, and an output process of outputting grayscale image data with a high resolution may be set as the output process to be executed third. In this case, if first image data to be output by the output process to be executed first is subjected to an output process of outputting color image data with a high resolution, the processor 20 generates second image data and third image data on the basis of the first image data.

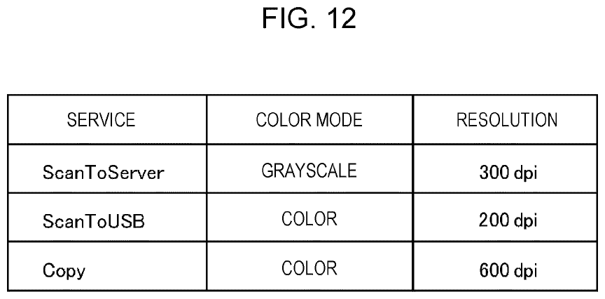

Hereinafter, the third example will be described by way of specific example. FIG. 12 illustrates settings for output processes according to the third example. “Service” indicated in FIG. 12 represents an output process.

In the third example, ScanToServer, ScanToUSB, and Copy are selected as output processes to be executed, as in the first and second examples.

The color mode of ScanToServer is grayscale. The resolution of ScanToServer is 300 dpi. That is, image data to be transmitted to a server by ScanToServer is grayscale image data with the resolution of 300 dpi.

The color mode of ScanToUSB is color. The resolution of ScanToUSB is 200 dpi. That is, image data to be stored into the USB memory by ScanToUSB is color image data with the resolution of 200 dpi.

The color mode of Copy is color. The resolution of Copy is 600 dpi. That is, image data to be subjected to Copy is color image data with the resolution of 600 dpi.

As in the first and second examples, the processor 20 first determines the order of output on the basis of color mode.

Since the color mode of ScanToServer is grayscale, the processor 20 determines that ScanToServer is the output process to be executed third.

The color modes of both ScanToUSB and Copy are color, that is, the same. Thus, the order of ScanToUSB and Copy is not determined only based on color mode.

Next, the processor 20 determines the order of ScanToUSB and Copy on the basis of resolution. The resolution of Copy is higher than the resolution of ScanToUSB. Thus, the processor 20 determines that Copy is the output process to be executed first and determines that ScanToUSB is the output process to be executed second.

As described above, the processor 20 determines that Copy is the output process to be executed first, ScanToUSB is the output process to be executed second, and ScanToServer is the output process to be executed third.

The resolution of ScanToUSB, which is the output process to be executed second, is 200 dpi, and the resolution of ScanToServer, which is the output process to be executed third, is 300 dpi. The resolution of ScanToServer is higher than the resolution of ScanToUSB. Image data with a high resolution is unable to be generated based on image data with a low resolution. Thus, the third image data to be output by the output process to be executed third is unable to be generated based on the second image data output by the output process to be executed second.

To handle this, in the third example, when executing a process regarding ScanToUSB, which is the output process to be executed second, the processor 20 generates third image data to be output by the output process to be executed third. That is, the processor 20 generates third image data based on first image data output by the output process to be executed first. Before executing an output process, the processor 20 stores into the memory 18 control information indicating that the third image data needs to be generated based on the first image data.

When the order of the output processes is determined, a document is read, and the output processes are executed in the order described above, as in the first and second examples. That is, Copy is executed for color first image data with the resolution of 600 dpi as a target.

When Copy ends, the processor 20 generates the second image data based on the first image data and stores the second image data into the memory 18. The processor 20 determines, by referencing the control information stored in the memory 18, whether or not the third image data needs to be generated based on the first image data. In the case where the third image data needs to be generated based on the first image data, the processor 20 generates the third image data based on the first image data and stores the third image data into the memory 18. When the second image data and the third image data are stored into the memory 18, the processor 20 deletes the first image data from the memory 18.

In a specific example, the processor 20 generates color second image data with the resolution of 200 dpi by converting the format of color first image data with the resolution of 600 dpi, and stores the second image data into the memory 18. The processor 20 stores the second image data into the USB memory by executing ScanToUSB, which is the output process to be executed second. When storing of the second image data into the USB memory is completed, the processor 20 deletes the second image data from the memory 18.

Furthermore, the processor 20 generates grayscale third image data with the resolution of 300 dpi by converting the format of the color first image data with the resolution of 600 dpi, and stores the third image data into the memory 18. The processor 20 transmits the third image data to a transmission destination server by executing ScanToServer, which is the output process to be executed third. When transmission of the third image data to the server is completed, the processor 20 deletes the third image data from the memory 18.

In the first to third examples described above, in the case where color image data is output, the processor 20 determines that an output process of outputting color image data with the highest resolution among multiple output processes is the output process to be executed first. For example, Copy is set as the output process to be executed first. In this case, the processor 20 reads a document by using the image forming unit 12, and generates image data to be output by the output process to be executed first.

In the case where color image data is not output, the processor 20 determines that an output process of outputting image data with the highest resolution among multiple output processes is the output process to be executed first.

Since image data to be output by the output process to be executed first is generated by reading a document, there is no need to generate image data that is not to be output.

As a comparative example, original image data is generated by reading a document on the basis of the maximum performance of the image forming apparatus 10, and image data to be output by output processes are generated based on the original image data. For example, in the first to third examples, the maximum resolution of image data output is 600 dpi. Assuming that the image forming apparatus 10 has the capability of generating image data with the resolution of 2400 dpi, in the comparative example, even if an output process of outputting image data with the resolution of 2400 dpi is not executed, image data with the resolution of 2400 dpi is generated as the original image data. Image data to be output by an output process is generated based on the original image data with the resolution of 2400 dpi. In the comparative example, the original image data that is not to be output by an output process is generated, which means that unnecessary image data is generated. Furthermore, the memory needs to secure a capacity large enough to store the original image data. In contrast, in the first to third examples, since unnecessary original image data is not generated, the load of generating such unnecessary original image data does not occur to the image forming apparatus 10. Furthermore, the memory does not need to secure a capacity large enough to store unnecessary original image data.

In the first to third examples described above, image data are output to multiple different output destinations. For example, an image based on image data is formed on a recording medium such as paper by Copy, image data is stored into the USB memory by ScanToUSB, and image data is transmitted to a server by ScanToServer.

As another example, a plurality of pieces of image data having different formats may be output to the same output destination. For example, transmission of a plurality of pieces of image data having different formats to the same server is also included in the scope of the concept of multiple different output processes.

In a specific example, image data with a high resolution is transmitted as original image data to the server 34 by ScanToServer, and image data with a low resolution is transmitted as image log data to the server 34 by ScanToServer. In this case, a plurality of pieces of image data with different resolutions are transmitted to the same server 34.

For example, ScanToServer of transmitting the image data with the high resolution to the server 34 is set as an output process that is higher in the order, and ScanToServer of transmitting the image data with the low resolution is set as an output process that is lower in the order. The processor 20 stores the image data with the high resolution into the memory 18 and transmits the image data with the high resolution to the server 34. When this transmission is completed, the processor 20 generates the image data with the low resolution by converting the image data with the high resolution. The processor 20 stores the image data with the low resolution into the memory 18 and deletes the image data with the high resolution from the memory 18. Next, the processor 20 transmits the image data with the low resolution to the server 34. When this transmission is completed, the processor 20 deletes the image data with the low resolution from the memory 18.

In the case where shortage of the capacity of the memory for storing image data is predicted during reading of a document, the processor 20 may stop the reading and output image data that has already been generated by execution of an output process. By deleting the output image data from the memory, the processor 20 secures the memory capacity for storing image data to be generated. When the capacity is secured, the processor 20 restarts reading of the document.

In the exemplary embodiment described above, image data to be subjected to an output process is generated by reading a document by using a scanner. However, image data to be subjected to an output process may be generated by photographing an object such as a document by using a camera. In this case, as in the exemplary embodiment described above, the processor 20 generates, for each output process, image data that has a format corresponding to the output process, and executes the output process in the order determined based on the format of the image data.

Part of the functions of the image forming apparatus 10 may be implemented by an apparatus different from the image forming apparatus 10. In the case where part of the functions of the image forming apparatus 10 is implemented by an apparatus different from the image forming apparatus 10, the image forming apparatus 10 and the apparatus may configurate the information processing system. That is, the functions of the image forming apparatus 10 may be implemented by the information processing system including a single apparatus or an information processing system including a plurality of apparatuses.

Functions of the image forming apparatus 10 are implemented by, for example, collaboration between hardware and software. For example, the processor 20 of the image forming apparatus 10 reads and executes a program stored in the memory so that the functions of the image forming apparatus 10 are implemented. The program is stored into the memory via a recording medium such as a CD or a DVD or via a communication path such as a network. In a similar manner, when the processor 20 of the image forming apparatus 10 reads and executes a program stored in the memory, functions of the image forming apparatus 10 are implemented. The program is stored into the memory via a recording medium such as a CD or a DVD or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

### (((1)))

An information processing system comprising:
a memory; and
a processor configured to:
   in a case where image data generated by reading a document is to be output by multiple different output processes, determine, based on formats of the image data to be output by the output processes, an order of output of the image data by the output processes;
   store first image data to be output by a first output process that is higher in the order of output among the multiple different output processes into the memory;
   output the first image data by the first output process;
   generate, based on the first image data, second image data to be output by a second output process that is lower in the order of output;
   store the second image data into the memory and delete the first image data from the memory; and
   output the second image data by the second output process.

### (((2)))

The information processing system according to (((1))), wherein the processor is configured to:
determine, based on whether or not image data to be output is color image data, the order of output; and
in a case where the first image data is color image data and the second image data is not color image data, generate the second image data based on the first image data, and after performing the output by the first output process, perform the output by the second output process.

### (((3)))

The information processing system according to (((2))), wherein the processor is configured to:
in a case where the first image data and the second image data are color image data, determine, based on a resolution of the first image data and a resolution of the second image data, the order of the output by the first output process and the output by the second output process; and
in a case where the resolution of the first image data is higher than the resolution of the second image data, generate the second image data based on the first image data, and after performing the output by the first output process, perform the output by the second output process.

### (((4)))

The information processing system according to (((3))), wherein the processor is configured to, in a case where the resolution of the first image data and the resolution of the second image data are the same, determine, based on priority levels set in advance, that the output by the first output process is to be executed earlier than the output by the second output process.

### (((5)))

The information processing system according to (((4))), wherein the priority levels are set every time that the image data is output by the multiple different output processes.

### (((6)))

The information processing system according to (((4))), wherein the processor is configured to display a user interface for allowing a user to set the multiple different output processes and the priority levels on a display.

### (((7)))

The information processing system according to any one of (((1))) to (((6))), wherein the processor is configured to, in a case where third image data is to be output by a third output process after the output by the second output process, if the third image data is unable to be generated based on the second image data, generate, based on the first image data, the second image data and the third image data.

### (((8)))

The information processing system according to (((7))), wherein the processor is configured to, in a case where the second image data is color image data, the third image data is not color image data, and a resolution of the second image data is lower than a resolution of the third image data, generate, based on the first image data, the second image data and the third image data.

### (((9)))

The information processing system according to any one of (((1))) to (((8))), wherein the processor is configured to:
in a case where color image data is to be output, set an output process of outputting color image data with the highest resolution among the multiple different output processes as an output process to be executed first, of outputting image data first among the multiple different output processes;
in a case where color image data is not to be output, set an output process of outputting image data with the highest resolution among the multiple different output processes as the output process to be executed first; and
generate, by reading the document, image data to be output by the output process to be executed first.

### (((10)))

A program causing a computer including a memory to execute a process comprising:
in a case where image data generated by reading a document is to be output by multiple different output processes, determining, based on formats of the image data to be output by the output processes, an order of output of the image data by the output processes;
storing first image data to be output by a first output process that is higher in the order of output among the multiple different output processes into the memory;
outputting the first image data by the first output process;
generating, based on the first image data, second image data to be output by a second output process that is lower in the order of output;
storing the second image data into the memory and deleting the first image data from the memory; and
outputting the second image data by the second output process.

What is claimed is:

1. An information processing system comprising:
a memory; and
a processor configured to:
in a case where image data generated by reading a document is to be output by multiple different output processes, determine, based on formats of the image data to be output by the output processes, an order of output of the image data by the output processes;
store first image data to be output by a first output process that is higher in the order of output among the multiple different output processes into the memory;
output the first image data by the first output process;
generate, based on the first image data, second image data to be output by a second output process that is lower in the order of output;
store the second image data into the memory and delete the first image data from the memory; and
output the second image data by the second output process.

2. The information processing system according to claim 1, wherein the processor is configured to:
determine, based on whether or not image data to be output is color image data, the order of output; and
in a case where the first image data is color image data and the second image data is not color image data, generate the second image data based on the first image data, and after performing the output by the first output process, perform the output by the second output process.

3. The information processing system according to claim 2, wherein the processor is configured to:
in a case where the first image data and the second image data are color image data, determine, based on a resolution of the first image data and a resolution of the second image data, the order of the output by the first output process and the output by the second output process; and
in a case where the resolution of the first image data is higher than the resolution of the second image data, generate the second image data based on the first image data, and after performing the output by the first output process, perform the output by the second output process.

4. The information processing system according to claim 3, wherein the processor is configured to, in a case where the resolution of the first image data and the resolution of the second image data are the same, determine, based on priority levels set in advance, that the output by the first output process is to be executed earlier than the output by the second output process.

5. The information processing system according to claim 4, wherein the priority levels are set every time that the image data is output by the multiple different output processes.

6. The information processing system according to claim 4, wherein the processor is configured to display a user interface for allowing a user to set the multiple different output processes and the priority levels on a display.

7. The information processing system according to claim 1, wherein the processor is configured to, in a case where third image data is to be output by a third output process after the output by the second output process, if the third image data is unable to be generated based on the second image data, generate, based on the first image data, the second image data and the third image data.

8. The information processing system according to claim 7, wherein the processor is configured to, in a case where the second image data is color image data, the third image data is not color image data, and a resolution of the second image data is lower than a resolution of the third image data, generate, based on the first image data, the second image data and the third image data.

9. The information processing system according to claim 1, wherein the processor is configured to:
in a case where color image data is to be output, set an output process of outputting color image data with the highest resolution among the multiple different output processes as an output process to be executed first, of outputting image data first among the multiple different output processes;
in a case where color image data is not to be output, set an output process of outputting image data with the highest resolution among the multiple different output processes as the output process to be executed first; and
generate, by reading the document, image data to be output by the output process to be executed first.

10. An information processing method comprising:
in a case where image data generated by reading a document is to be output by multiple different output processes, determining, based on formats of the image data to be output by the output processes, an order of output of the image data by the output processes;
storing first image data to be output by a first output process that is higher in the order of output among the multiple different output processes into the memory;
outputting the first image data by the first output process;
generating, based on the first image data, second image data to be output by a second output process that is lower in the order of output;
storing the second image data into the memory and deleting the first image data from the memory; and
outputting the second image data by the second output process.

11. A non-transitory computer readable medium storing a program causing a computer including a memory to execute a process comprising:
in a case where image data generated by reading a document is to be output by multiple different output processes, determining, based on formats of the image data to be output by the output processes, an order of output of the image data by the output processes;
storing first image data to be output by a first output process that is higher in the order of output among the multiple different output processes into the memory;
outputting the first image data by the first output process;
generating, based on the first image data, second image data to be output by a second output process that is lower in the order of output;
storing the second image data into the memory and deleting the first image data from the memory; and
outputting the second image data by the second output process.
